(19) United States
(12) Patent Application Publication
(10) Pub. No.: US 2025/0293278 A1
(43) Pub. Date: Sep. 18, 2025

(54) Advanced Hydrogen Fuel Cell

(71) Applicant: Rodolfo Antonio M. Gomez, Netley (AU)

(72) Inventor: Rodolfo Antonio M. Gomez, Netley (AU)

(21) Appl. No.: 18/774,611

(22) Filed: Jul. 16, 2024

Related U.S. Application Data
(63) Continuation of application No. PCT/AU2024/050125, filed on Feb. 20, 2024.

(30) Foreign Application Priority Data
Jan. 22, 2024 (AU) 2024900141

(51) Int. Cl. H01M 8/0656; H01M 8/0202

(52) U.S. Cl. CPC H01M 8/0656; H01M 8/0202; H01M 2250/10; H01M 2300/0005; H01M 2300/0014

(57) ABSTRACT

An advanced hydrogen fuel cell system in which the anode cell includes an acidic electrolyte and the cathode cell includes an alkaline electrolyte, operation of improved advanced hydrogen fuel cell system yields an increase in the generation of fuel cell voltage in comparison to known hydrogen fuel cell. In addition, the advanced hydrogen fuel cell system is compatible with water electrolysis processes, in particular unipolar electrolysis of water that further increases the energy output of the system and efficiency.

### CROSS-REFERENCE TO RELATED APPLICATIONS

This application is a Bypass Continuation of International Patent Application No. PCT/AU2024/050125 filed Feb. 20, 2024, and claims priority to Australian Patent Application No. 2024900141 filed Jan. 22, 2024, the disclosures of which are hereby incorporated by reference in their entireties.

### BACKGROUND

### Technical Field

The present application relates to improvements to hydrogel fuel cells and discloses an improved advance hydrogen fuel cell that produces a voltage Eₒ of 2.057 volts instead of the conventional Eₒ of 1.229 volts, increasing the voltage output of the improved advanced fuel cell by 67%. The current or power output of this fuel cell will depend on the activity of the catalysts in the electrodes and the electrical resistance of the fuel cell circuit.

### Description of Related Art

A conventional hydrogen fuel cell is shown on FIG. 1A and FIG. 1B. The electrolyte in the anode cell 10 is alkaline in FIG. 1A, the electrolyte being, for example, potassium hydroxide and the same at the cathode cell 15. The anode electrode 20 is a conductor coated with a catalyst such as platinum while the cathode 25 is a conductor coated with a catalyst such as iridium. A membrane 30 that is non-conductive but allows hydrogen protons 35 to pass through separates the anode cell 10 from the from the cathode cell 15. When hydrogen is applied at the anode, the hydrogen is catalyzed into protons and electrons, with the reaction;

H₂→2H⁺+2e⁻

The protons pass through the membrane 30 to the cathode cell 15 while the electrons on the anode electrode 20 pass through the external circuit 40 through the electrical load 45 and into the cathode electrode 25. The protons, electrons and oxygen introduced into the cathode cell 15 react to complete the fuel cell reaction:

1/2O₂+2H⁺+2e⁻→H₂O

The half-cell voltage generated at the anode 20 is 0.401 volts while the half-cell voltage generated at the cathode 25 is 0.828 volts so that the cell voltage Eₒ is 1.229 volts.

Similarly, as shown in FIG. 1B, if the electrolytes at the anode cell 60 and at the cathode cell 70 are acid such as phosphoric acid, the process of the fuel cell is the same, with the anode 65, cathode 75 separated by the membrane 80 except the half-cell voltage at the anode 65 is 1.229 volts while the half-cell voltage at the cathode 75 is 0.000 volts, resulting in an Eₒ voltage of the cell of 1.229 volts.

### SUMMARY

It is generally accepted that hydrogen will be the clean energy of the future to replace carbon fuels to stop the production of greenhouse gasses and prevent catastrophic climate change that will put our World in jeopardy. The present invention aims to increase the power output of the hydrogen fuel cell when converting hydrogen into electricity and mechanical power.

In one form of the invention there is a fuel cell system comprising:
at least a first cell having at least one anode compartment housing an anode electrode and acidic electrolyte, at least one cathode compartment housing a cathode electrode and alkaline electrolyte, the at least one anode compartment and the at least on cathode compartment being separated by a partition member. In preference, the partition member is a non-conducting porous diaphragm or a membrane or a non-conducting salt bridge connecting the anode electrolyte and cathode electrolyte but allows the hydrogen proton to pass from the anode to the cathode.

In preference, the partition member allows for selective passage of hydrogen ions therethrough.

In preference, the at least one material coating the anode or cathode electrodes is selected from the group of the metals, alloys or oxides thereof comprising ruthenium, iridium, rhodium, nickel, cobalt, molybdenum, copper, zinc, platinum, palladium, gold, silver, or rare earth elements.

In preference, the fuel cell system is combined with a water electrolysis system/unit.

In preference, the water electrolysis system/unit is a unipolar water electrolysis system/unit.

In preference, the fuel cell system generates electrical energy for a power generation apparatus.

In preference, the power generation apparatus includes the fuel cell system operatively coupled to the unipolar water electrolysis system/unit to provide an increased electrical energy output.

In preference, the increased electrical energy output is an increase of >50%. The power output of the improved advanced fuel cell will depend on the activity of the catalysts, the area of the electrodes, the operating temperature and pressure and the electrical resistance of the fuel cell electrical circuit.

In preference, the unipolar water electrolysis system includes an electrolytic system comprising: at least first electrolytic cell having at least one anode compartment housing an anode electrode and alkaline electrolyte producing oxygen and at least one cathode compartment housing a cathode electrode and acidic electrolyte producing hydrogen with a partition member separating the anode compartment from the cathode compartment and a DC power supplied to the anode and cathode electrodes;
at least a second electrolytic cell having at least one cathode compartment housing a cathode electrode receiving the positively charged alkaline electrolyte from the first anode cell and producing hydrogen, and having at least one anode compartment housing an anode electrode and receiving the negatively charged acidic electrolyte from the first cathode cell and producing oxygen with a partition member separating the anode cell from the cathode cell, when the anode electrodes and the cathode electrodes are connected in short circuit producing hydrogen and oxygen without a DC power supply;
wherein at least there is one partition member separating the anode and cathode compartments in each of the first and second fuel cells; and
wherein the partition member is a porous diaphragm or an electronic membrane.

In preference, the fuel cell system in combined with a water electrolysis system provides a synergistic increase in energy generation.

In preference, the fuel cell system includes a plurality of additional fuel cell systems, each additional fuel cell system having an anode compartment housing an anode electrode and acidic electrolyte, and a cathode compartment housing a cathode electrode and alkaline electrolyte, the at least one anode compartment and the at least on cathode compartment being separated by a partition member.

In preference, the anode electrode in the anode compartment of the each additional fuel cell system is electrically coupled to the preceding cathode electrode of the preceding fuel cell system.

In preference, the cathode electrode in the cathode compartment of the each additional fuel cell system is electrically coupled to the successive anode electrode of the preceding fuel cell system.

In a further form of the invention, there is an apparatus for producing electrical energy, the apparatus comprising a fuel cell system comprising:
at least a first fuel cell having at least one anode compartment housing an anode electrode and acidic electrolyte, at least a second fuel cell having at least one cathode compartment housing a cathode electrode and alkaline electrolyte, the at least first fuel cell and the at least second fuel cell being separated by a partition member.

A unipolar water electrolysis unit to produce hydrogen gas and oxygen gas, the produced hydrogen gas being stored in a hydrogen gas storage tank, the produced oxygen gas being stored in an oxygen storage tank, each of the hydrogen gas storage tank and oxygen gas storage tank being fluidly connected to a hydrogen fuel cell to produce electrical energy.

In one form of the invention there is an apparatus for producing electrical energy, the apparatus comprising a unipolar water electrolysis unit operatively coupled to the fuel cell system of the present invention and fluidly connected to a hydrogen fuel cell.

In a further form of the invention, there is an apparatus for producing electrical energy, the apparatus comprising the fuel cell system of the present invention operatively coupled a unipolar water electrolysis unit to produce hydrogen gas and oxygen gas, the produced hydrogen gas being stored in a hydrogen gas storage tank, the produced oxygen gas being stored in an oxygen storage tank, each of the hydrogen gas storage tank and oxygen gas storage tank being fluidly connected to a hydrogen fuel cell to produce electrical energy.

In preference, the unipolar water electrolysis unit having an anode side with an anode cell and a cathode side with a cathode cell.

In preference, the apparatus includes a water storage unit fluidly connected to the anode cell.

In preference, the apparatus includes a water storage unit fluidly connected to the cathode cell.

In preference, the anode cell of the unipolar water electrolysis includes:
an alkaline electrolyte producing oxygen and the cathode cell includes an acidic electrolyte producing hydrogen with a partition member separating the anode cell from the cathode cell;
a DC power supply connected to the anode and cathode cells; and
at least a second electrolytic cell having at least one cathode compartment housing a cathode electrode receiving the positively charged alkaline electrolyte from the first anode cell and producing hydrogen, and
having at least one anode compartment housing an anode electrode and receiving the negatively charged acidic electrolyte from the first cathode cell and producing oxygen with a partition member separating the anode cell from the cathode cell, when the anode electrodes and the cathode electrodes are connected in short circuit;
wherein at least there is one partition member separating the anode and cathode compartments in each of the first and second electrolytic cells.

In preference, the apparatus includes a diaphragm-less anode cell to produce oxygen wherein the anode cell has an anode and an anode solution electrode, the anode being connected to a DC power source, a diaphragm-less cathode cell to produce hydrogen wherein the cathode cell has a cathode and a cathode solution electrode, the cathode being connected to the DC power source, the anode solution electrode connected to the cathode solution electrode by an external conductor, means to supply a first electrolyte to the anode cell, means to supply a second electrolyte to the anode cell and means to apply a DC current from the DC power source to the anode and the cathode, wherein the first electrolyte and the second electrolyte are the same electrolyte and the means to supply the first electrolyte to the anode cell supplies the second electrolyte and the means to supply the second electrolyte to the anode cell supplies the first electrolyte and further including means to separate hydrogen from the second electrolyte between the cathode cell and the anode cell and means to separate oxygen from the first electrolyte between the anode cell and the cathode cell.

### BRIEF DESCRIPTION OF THE DRAWINGS

FIG. 1A and FIG. 1B are diagrammatic views of a conventional hydrogen fuel cell with membrane (prior art);

FIG. 2 is a diagrammatic of an embodiment of the hydrogen fuel cell of the present invention having a fuel cell system with diaphragm to separate the anode and cathode compartment;

FIG. 3 is a diagrammatic view of an embodiment of the present invention having multiple fuel cells;

FIG. 4 is a further view of FIG. 3, showing detail of a process diagram with recirculation of electrolytes for both the anode compartment and the cathode compartment.

### DETAILED DESCRIPTION

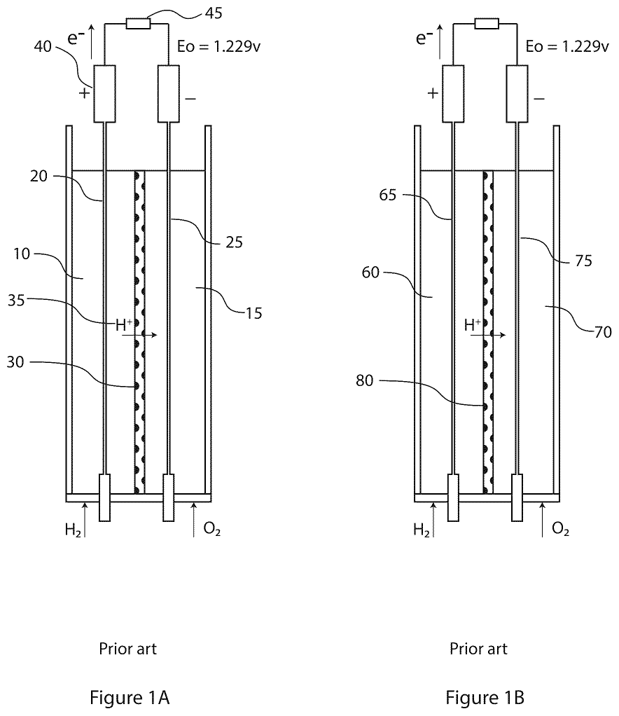

As shown in FIG. 1A and FIG. 1B (prior art), there is a conventional fuel cell.

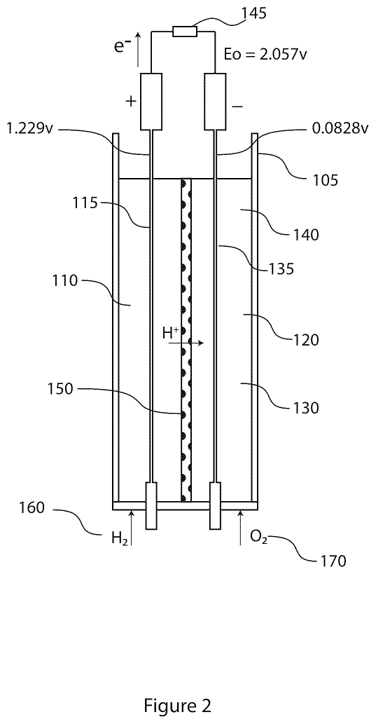

Turning to FIG. 2, which shows an embodiment of the present invention of the fuel cell system 100 including a first fuel cell 105 having as anode compartment 110 housing an anode electrode 115 and acidic electrolyte 120. Adjacent to the first fuel cell 105 is a second fuel cell 130, housing a cathode electrode 135 and alkaline electrolyte 140. Located between the first fuel cell 110 and second fuel cell 130 is a membrane 150 being a commercially available fuel membrane that allows for the selective passage of electrons.

Alternatively, the membrane 150 can be a non-conducting partition with a salt bridge connecting the anode electrolyte to the cathode electrolyte or a porous diaphragm, proton exchange membrane or similar.

At the anode cell 110, hydrogen 160 is introduced into the acidic electrolyte 120, and the introduced hydrogen is catalyzed into the protons and electrons, with the reaction;

H₂→2H⁺+2e⁻

The produced electrons then travel up the anode electrode 115, though the load 145 and into the cathode electrode 135 of the cathode compartment 120, which has an alkaline electrolyte. Hydrogen (H+) produced in the anode compartment 110 in the acidic electrolyte 120 then can pass though the selective barrier/membrane 150 and into the alkaline electrolyte 140 of the cathode compartment 120, into which oxygen 170 is introduced where the fuel cell reaction is completed:

1/2O₂+2H⁺+2e⁻→H₂O

The protons pass through the membrane to the cathode cell while the electrons pass through the external circuit through the electrical load and into the cathode electrode. The protons, electrons and oxygen introduced into the cathode cell react to complete the fuel cell reaction.

Surprisingly, the half-cell voltage at the anode electrode 115 was measured at 1.229 volts and the half-cell voltage at the cathode electrode 135 was measured at 0.828 volts, resulting in the total cell voltage Eₒ=1.229+0.828=2.057 volts, which was most unexpected.

The cell voltage of 2.057 volts from the present invention 100 represents an increase of 67.4% over the conventional 1.229 volts from the prior art fuel cells as shown in FIG. 1A and FIG. 1B. For the same hydrogen feed, the voltage output of the advanced hydrogen fuel cell is 67.4% higher than the voltage output of the conventional hydrogen fuel cell.

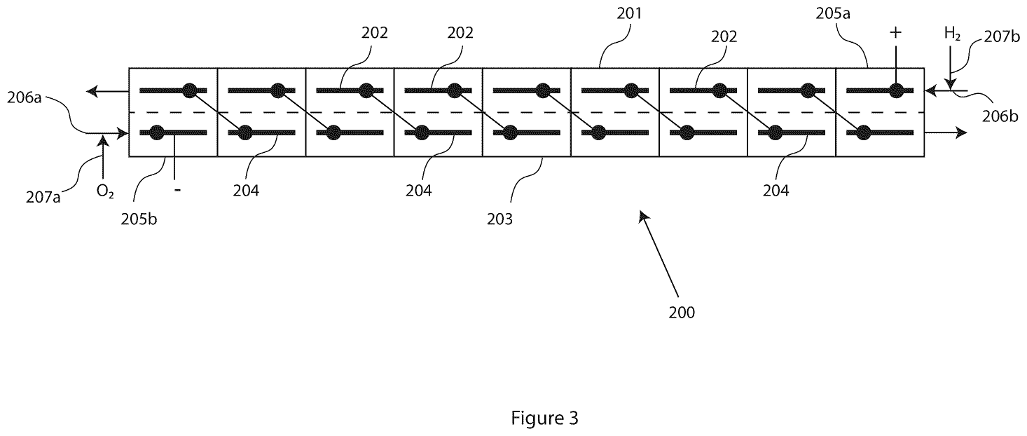

In a commercially relevant example in FIG. 3, there is a plurality of interconnected fuel cells 200. The alkaline electrolyte and oxygen are fed at the cathode cell and then pass through a series of cells while the acid and hydrogen are fed at the anode at the other end and pass through the electrolytic cells. The electrodes are connected in series as shown in FIG. 3 and the resulting theoretical voltage is 18.513 volts compared to a conventional cell group of 11.061 volts.

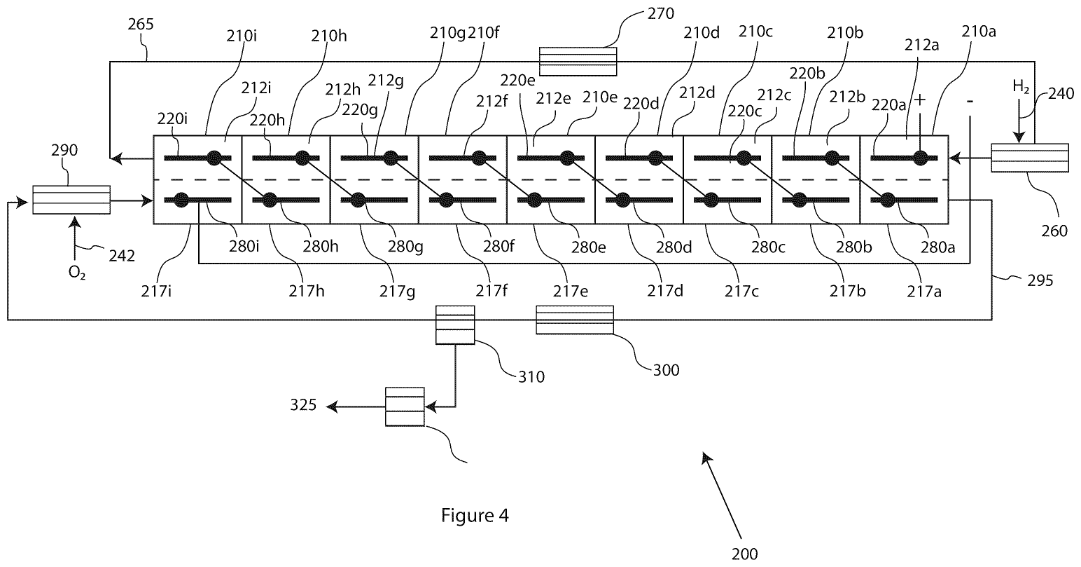

As shown in FIG. 4, which is a process diagram of FIG. 3, the present invention is modified to provide a plurality of interconnected cells, connected to increase the voltage output. The combined/connected fuel cell 200 includes a plurality of combined fuel cells 210a-210i, each have their own separate anode compartment 212a-212i with an anode electrode 215a-215i, each in an acidic electrolyte and separate cathode compartment 217a-217i with a cathode electrode 220a-220i.

Each of the anode electrodes 215b-215i are electrically coupled to the preceding cathode electrodes 220a-220H of the preceding fuel cell system.

Hydrogen 240 is introduced into anode compartment 212a of the first fuel cell 210a via the mixer 260, where it is pre-mixed with the acidic electrolyte and introduced into the first fuel cell 210a. Each of the anode compartments 210a-210i are fluidly connected to allow the acidic electrolyte to pass from one anode compartment to the next. At the end of the fuel cell 200 the acidic electrolyte in anode compartment 212i is then directed to a heating/cooling unit 270, after which it is then returned to the mixer 260 for additional addition of hydrogen and then returned into the anode compartment 212a first fuel cell 210a.

On the cathode side of the combined fuel cell 200 there are a plurality of cathode compartments 217a-217i with cathode electrodes 280a-280i. Oxygen is introduced into the mixer 290 where it is mixed with incoming alkaline electrolyte and the resulting alkaline electrolyte/O₂ mixture is directed into first cathode compartment 217i of fuel cell 280i. Each of the cathode compartments 217a-217i of the fuel cells 210a-210i are fluidly connected to allow the alkaline electrolyte to pass from one fuel cell to the next, ie alkaline electrolyte in the cathode compartment 217i of fuel fell 210i can then pass into cathode compartment 217h of fuel cell 210h and so on up to the cathode compartment 217a of the fuel cell 210a, where it is then directed to a heater unit 300. Post heated alkaline electrolyte is then subjected to evaporation in an evaporation unit 310 to recover and remove water, which can then be condensed by condenser unit 320 and directed to the operatively/fluidly connected unipolar electrolyser.

In the group of nine fuel cells described in FIG. 3 and FIG. 4, acid electrolyte and hydrogen are fed to the anode cells at one end while alkaline electrolyte and oxygen are fed to the cathode cells at the other end. This counter current balances the high concentration of hydrogen at the anode and oxygen at the cathode. The use of a heater or cooler is dependent on operating conditions for the acid electrolyte but the alkaline electrolyte is treated to remove the water formed in the fuel cell reaction. If the alkaline electrolyte is hot enough from the fuel cell reactions, the heater may not be required but the evaporator and condenser will be required to remove the water produced by the fuel cell and this water is recycled to the Unipolar electrolyser.

The electric power produced by the present invention is shown on Table 1 compared to the electric power produced by a conventional hydrogen membrane fuel cell.

Calculation of hydrogen heating value

| | |
|---|---|
| Faraday, coulombs (ampere-seconds) | 96, 485.30 |
| 1 Hr, seconds | 3600 |
| Amperes per hr | 26.80 |
| Hydrogen produced in 1 hr with current of 26.80147, | 1.00794 |
| grams | |

Conventional prior art hydrogen fuel cell

| | |
|---|---|
| Conventional fuel cell voltage, volts | 2.229 |
| Hydrogen heating value, kilowatt-hours per kg (kwh/kg) | 32.68 |

Present invention hydrogen fuel cell

| | |
|---|---|
| fuel cell voltage, volts | 2.057 |
| Hydrogen heating value, kilowatt-hours per kg (kwh/kg) | 54.70 |
| Increase in power output per kg of H₂, % | 67.37 |

A kilogram of hydrogen feed to a conventional prior art hydrogen fuel cell will produce 32.68 kilowatt-hours; however, a kilogram of hydrogen feed to an advanced hydrogen membrane fuel cell will produce 54.70 kilowatt-hours. A surprising increase of 67% in the voltage output of the advanced hydrogen membrane fuel cell

### Applications

The major carbon pollution of the World comes from land, water and air transportation and from electricity production.

A sustainable water fueled vehicle is powered by the Unipolar electrolysis of water and the improved advanced hydrogen fuel cell. Unipolar electrolysis of water based on US

U.S. Pat. No. 10,314,316 where the electrolysis of water to produce hydrogen can be brought down to as low as 5.373 kilowatt-hours per kilogram of hydrogen.

The Unipolar process consists of an alkaline electrolyte being used at the anode cell while acidic electrolyte is used at the cathode cell, reducing the cell voltage to 0.401 volts, instead of 1.229 volts. A conventional diaphragm cell allows H⁺ and OH⁻ ions to migrate across the diaphragm however the unipolar process as per U.S. Pat. No. 10,314,316, the diaphragm allows only electrons to pass resulting in the build up of negative ions at the cathode cell and positive ions at the anode cell. The negatively and positively charged electrolytes are passed through another cell, current flows and according to Faraday, an additional reaction takes place producing additional H₂ and O₂.

The energy required to produce 1 kg of H2 is reduced by (1.229/0.401)×2=6.13 times, or 5.373 kwh/kg compared to conventional process which are 32.938 kwh/kg.

Conventional electrolysis of water to produce hydrogen requires 32.938 kilowatt-hours of electricity to produce 1 kilogram of hydrogen. Unipolar electrolysis of water requires as low as 5.373 kilowatt-hours to produce 1 kilogram of hydrogen. The Unipolar electrolysis of water is required in the following applications of the advanced hydrogen membrane fuel cell (AHMFC)

TABLE 2
Calculations for a sustainable water fuelled vehicle
for conventional fuel cells (Fuel cell A) and improved
fuel cell of the present invention (Fuel cell B)

| | Fuel cell | Fuel cell |
|---|---|---|
| | A | B |
| Assumptions | | |
| Electrolyser efficiency, kw/kg hydrogen | 15 | 15 |
| H₂ storage for 350 atmospheres, kwh/kg | 4.01 | 4.01 |
| Storage pressure for H₂ and O₂, | 15 | 15 |
| atmospheres | | |
| Fuel cell efficiency % | 85 | 72 |
| Lower heat content of H₂, kwh/kg | 32.68 | 54.70 |
| Output of neutralising cells of | 95 | 95 |
| electrolyser, % | | |
| Calculations | | |
| H₂ produced by charging cells, kg | 1.295 | 1.295 |
| H₂ produced by neutralising cells, kg | 1.23 | 1.23 |
| Total H₂ produced by unipolar | 2.53 | 2.53 |
| electrolysis, kg | | |
| O₂ required by hydrogen fuel cell, kg | 20.202 | 20.202 |
| Electricity for compressing H₂, kwh | 0.43 | 0.43 |
| Electricity for compressing 1 kg of O₂, kwh | 0.011 | 0.011 |
| Electricity for compressing O₂, kwh | 0.22 | 0.22 |
| Total electricity for compression, kwh | 0.65 | 0.65 |
| Gross electricity generated, kwh | 70.15 | 99.45 |
| Electricity for unipolar electrolysis, kwh | 19.425 | 19.43 |
| Net electricity for driving wheels, kwh | 50.07 | 79.37 |

In Table 2, with the fuel cell of the present invention, Fuel cell B, the Unipolar electrolyser efficiency is shown at 15 kwh/kg but the advanced fuel cell production of electricity is 54.70 kwh/kg from Table 1. After allowing for the Unipolar electrolysis of water of 19.43 kwh and 0.65 kwh for the compression of hydrogen and oxygen, 79.37 kilowatt-hours are available to drive the wheels of the vehicle. The electricity to extract the water from the fuel cell and recycle it to the Unipolar electrolysis has not been considered. The application of the Advanced Hydrogen Membrane Fuel cell of the present invention in the water fueled transport vehicle has increased the electricity available to drive the wheels of the transport vehicle by 59%. This technology will apply to large trucks, locomotives, mining and agricultural equipment, small boats and large ships, and slow and high speed aircrafts. High speed aircrafts fitted with rocket type engines does not recycle the water and must carry enough water to last the journey. This technology applies also to the production of clean electricity.

### Electricity Production

TABLE 3
shows Water Fueled Vehicle applied to electricity production.

| | Electricity | Electricity |
|---|---|---|
| | With Solar | Without Solar |
| | Feed | Feed |
| Stage 1 | | |
| Wind, Solar Electricity, | 100 | 100 |
| Billion kwh | | |
| Unipolar Electrolyser | 12 | 12 |
| Efficiency, kwh/kg | | |
| Hydrogen, produced, kg | 8,333,333,333 | 8,333,333,333 |
| Advanced Fuel Cell | 54.7 | 54.7 |
| production, kwh/kg | | |
| Advanced Fuel Cell | 72 | 72 |
| Efficiency, % | | |
| Gross Electricity Output, kwh | 328,200,000,000 | 328,200,000,000 |
| Electricity for Compression of | 0.5 | 0.5 |
| H2 and O2. kwh/kg | | |
| Electricity for Unipolar | 0 | 12 |
| Electrolysis, kwh/kg | | |
| Electricity for Unipolar and | 0.5 | 12.5 |
| Compression, kwh/kg | | |
| Elect. For Unipolar and | 4,166,666,667 | 104,166,666,667 |
| Compression, kwh | | |
| Net Electricity Produced, | 324.03 | 224.03 |
| Billion kwh | | |
| Stage 2 | | |
| Electricity fed to Stage 2, | 324.03 | 224.03 |
| Billion kwh | | |
| Unipolar Electrolyser | 12 | 12 |
| Efficiency, kwh/kg | | |
| Hydrogen, produced, kg | 27,002,777,778 | 18,669,444,444 |
| Advanced Fuel Cell | 54.7 | 54.7 |
| production, kwh/kg | | |
| Advanced Fuel Cell | 72 | 72 |
| Efficiency, % | | |
| Gross Electricity Output, kwh | 807,947,413,611 | 735,277,400,000 |
| Electricity for Compression of | 0.5 | 0.5 |
| H2 and O2. kwh/kg | | |
| Electricity for Unipolar | 0 | 0 |
| Electrolysis, kwh/kg | | |
| Electricity for Unipolar and | 0.5 | 0.5 |
| Compression, kwh/kg | | |
| Elect. For Unipolar and | 13,501,388,889 | 9,334,722,222 |
| Compression, kwh | | |
| Net Electricity Produced, | 794.45 | 725.94 |
| Billion kwh | | |

In water fueled green electricity generation, solar, hydro or wind renewable energy is required only to supply electricity to the Unipolar electrolyser to fill up the hydrogen and oxygen storage in a first stage, Stage 1. After that, the renewable energy produced is no longer required so that the electricity production can proceed even when there is no feed of electricity from renewable sources. There will be less electricity when there is no sun or wind supplying the initial Stage 1.

Table 3 shows the amount of electricity produced after Stage 1 is 324.03 billion kwh from a start of 100 billion kwh from solar or wind. Feeding the electricity from Stage 1 to Stage 2 result in a production of 794.454 billion kwh or an increase of 7.94 times from the original feed of 100 billion kwh.

When the renewable electricity is not available, electricity continues to be produced but it is less as shown in Table 3 where 224.03 billion kwh is produced after Stage 1 and 725.94 billion kwh is produced after Stage 2. Provided the hydrogen and oxygen storage tanks are full, when there is no solar or wind electricity, the electricity production in Stage 1 is 224.03 billion kwh. When this is fed to Stage 2, the production of electricity is 725.94 billion kwh. This is about 8.6% less. In this case more electricity production can be achieved by adding more hydrogen and oxygen storage.

### Water Fueled Jet Airliner

One of the major causes of carbon pollution are the jet airliners used for commercial transport. It is not only carbon dioxide but nitrous oxide and unburnt hydrocarbons that are delivered high up in the atmosphere. An example of the application of water fuel is where the jet liner uses up the water and must carry enough water for the journey.

Hydrogen has about three times the energy content of jet fuel and the rocket is a more efficient engine than the kerosene jet engine so that the water fueled rocket engine will have a longer range, plus the rocket engine has no moving parts so that its operation is much safer and lower maintenance cost. For low speed aircraft driven by propellers, the advanced fuel cell of the present invention delivers the electrical energy to the motors driving the propellers. The water produced by the advanced fuel cell of the present invention is recycled to the Unipolar electrolyser. This gives a very long range to the low speed aircraft.

### Water Fueled Submarine

An important requirement of a good submarine is its to be undetectable. A hydrogen powered submarine using the fuel cell of the present invention has only the motor driving the propellers. By having dual motors powered by the present invention it would be easy to be able to run the submarine with the motor bank that is furthest away from the any detecting stations. For example, if a detecting station, sonar detector for example, is at the port side of the submarine, only run the submarine with the starboard fuel cell motor and propeller.

Aside from being quiet and long range, the water fueled submarine has no heat or hydrocarbon signature that will offer a means of detection.

### Cargo/Bulk Carrier Ship

A major user of petroleum fuel are large ships, bulk carriers, passenger ships and military vessels from frigates to aircraft carriers. These can all be fueled by water using the Unipolar electrolysis and the improved advanced hydrogen membrane fuel cell of the present invention which will provide the vessel with infinite range and low operating cost, with no carbon pollution.

A. A process where an advanced hydrogen fuel cell where acid electrolyte is used at the anode cell and alkaline electrolyte is used at the cathode cell separated by an electrically non-conducting membrane or diaphragm that allows the hydrogen proton to pass from the anode to the cathode and where hydrogen is fed to the anode cell and oxygen is fed to the cathode cell resulting in a cell voltage of 2.057 instead of the conventional cell voltage of 1.229 volts, and where this advanced hydrogen fuel cell is used in combination with Unipolar electrolysis of water described in applicants U.S. Pat. No. 10,314,316 to produce more electricity, allowing the use of water to fuel electric power generation and transport vehicles such as cars, trucks, mining and agricultural equipment, small boats and large ships, slow moving aircrafts and jet type aircrafts.

B. Where the power output of this invention and the Unipolar electrolysis of water according to US Patent 10,314,316 result in increase from the conventional hydrogen fuel cell of 32.68 kilowatt-hours per kilogram of hydrogen to 54.7 kilowatt-hours per kilogram of hydrogen according to this application, an increase of 67.38 percent.

C. Where substantial clean electricity production is possible even when there is no electricity feed from renewable sources such as solar, wind or hydro

D. Where transport vehicles such as cars, trucks, locomotives, mining equipment, agricultural equipment, small boat, large ships and slow moving aircraft can use water as a fuel indefinitely, making up only for losses of water during the process.

E. Where a jet type airliner uses a rocket type engine and uses the water on board for propulsion so that this jet plane must carry enough water for the journey.

F. An apparatus where an improved advanced hydrogen fuel cell where acid electrolyte is used at the anode cell and alkaline electrolyte is used at the cathode cell separated by an electrically non-conducting membrane or diaphragm that allows the hydrogen proton to pass from the anode to the cathode and where hydrogen is fed to the anode cell and oxygen is fed to the cathode cell resulting in a cell voltage of 2.057 instead of the conventional cell voltage of 1.229 volts, and where this advanced hydrogen fuel cell is used in combination with Unipolar electrolysis of water described in applicants U.S. Pat. No. 10,314,316 to produce more electricity, allowing the use of water to fuel electric power generation and transport vehicles such as cars, trucks, mining and agricultural equipment, small boats and large ships, slow moving aircrafts and jet type aircrafts.

G. Where the power output of this invention and the Unipolar electrolysis of water according to U.S. Pat. No. 10,314,316 result in increase from the conventional hydrogen fuel cell of 32.68 kilowatt-hours per kilogram of hydrogen to 54.7 kilowatt-hours per kilogram of hydrogen according to this application, an increase of 67.38 percent.

H. Where substantial clean electricity production is possible even when there is no electricity feed from renewable sources such as solar, wind or hydro.

I. Where transport vehicles such as cars, trucks, locomotives, mining equipment, agricultural equipment, small boat, large ships and slow moving aircraft can use water as a fuel indefinitely, making up only for losses of water during the process.

J. Where a jet type airliner uses a rocket type engine and uses the water on board for propulsion so that this jet plane must carry enough water for the journey,

K. An apparatus where electricity from a fuel cell is used in a Unipolar electrolysis of water according to my U.S. Pat. No. 10,314,316 where the hydrogen and oxygen are stored before being fed to the fuel cell where enough electricity is produced to power the Unipolar electrolyser, the storage of the hydrogen and oxygen, and to power the driving wheels of a vehicle, and the water produced by the fuel cell is recycled to the Unipolar electrolyser.

L. A process when used for producing electrical energy using the power generation apparatus as in any one of H-Q

1. A fuel cell system comprising:
at least a first cell having at least one anode compartment housing an anode electrode and acidic electrolyte, at least one cathode compartment housing a cathode electrode and alkaline electrolyte, the at least one anode compartment and the at least one cathode compartment being separated by a partition member.

2. The fuel cell system of claim 1, wherein the partition member is a porous diaphragm or a membrane or a non-conducting partition with a salt bridge connecting the anode electrolyte to the cathode electrolyte.

3. The fuel cell system of claim 1, wherein the partition member allows for selective passage of hydrogen ions therethrough.

4. The fuel cell system of claim 1, wherein the at least one material coating the anode or cathode electrodes is selected from the group of the metals, alloys or oxides thereof comprising ruthenium, iridium, rhodium, nickel, cobalt, molybdenum, copper, zinc, platinum, palladium, gold, silver, or rare earth elements.

5. The fuel cell system of claim 1, wherein the fuel cell system is combined with a water electrolysis system/unit.

6. The fuel cell system of claim 5, wherein the water electrolysis system/unit is a unipolar water electrolysis system/unit.

7. The fuel cell system of claim 1, wherein the fuel cell system generates electrical energy for a power generation apparatus.

8. The fuel cell system of claim 7, wherein the power generation apparatus comprises the fuel cell system operatively coupled to the unipolar water electrolysis system/unit to provide an increased electrical energy output.

9. The fuel cell system of claim 8, wherein the increased electrical energy output is an increase of >50%.

10. The fuel cell system of claim 1 resulting in a cell voltage Eₒ of 2.057 volts.

11. The fuel cell system of claim 6, wherein the unipolar water electrolysis system comprises an electrolytic system comprising: at least first electrolytic cell having at least one anode compartment housing an anode electrode and alkaline electrolyte producing oxygen and at least one cathode compartment housing a cathode electrode and acidic electrolyte producing hydrogen with a partition member separating the anode compartment from the cathode compartment and a DC power supplied to the anode and cathode electrodes;
at least a second electrolytic cell having at least one cathode compartment housing a cathode electrode receiving the positively charged alkaline electrolyte from the first anode cell and producing hydrogen, and having at least one anode compartment housing an anode electrode and receiving the negatively charged acidic electrolyte from the first cathode cell and producing oxygen with a partition member separating the anode cell from the cathode cell, when the anode electrodes and the cathode electrodes are connected in short circuit producing hydrogen and oxygen without a DC power supply;
wherein at least there is one partition member separating the anode and cathode compartments in each of the first and second fuel cells; and
wherein the partition member is a porous diaphragm or an electronic membrane.

12. The fuel cell system of claim 5, wherein the fuel cell system in combination with a water electrolysis system provides a synergistic increase in energy generation.

13. The fuel cell system of claim 1, wherein the fuel cell system comprises a plurality of additional fuel cell systems, each additional fuel cell system having an anode compartment housing an anode electrode and acidic electrolyte, and a cathode compartment housing a cathode electrode and alkaline electrolyte, the at least one anode compartment and the at least on cathode compartment being separated by a partition member.

14. The fuel cell system of claim 1, wherein the anode electrode in the anode compartment of the each additional fuel cell system is electrically coupled to the preceding cathode electrode of the preceding fuel cell system.

15. The fuel cell system of claim 1, wherein the cathode electrode in the cathode compartment of the each additional fuel cell system is electrically coupled to the successive anode electrode of the preceding fuel cell system.

16. An apparatus for producing electrical energy, the apparatus comprising a fuel cell system comprising:
at least a first fuel cell having at least one anode compartment housing an anode electrode and acidic electrolyte, at least a second fuel cell having at least one cathode compartment housing a cathode electrode and alkaline electrolyte, the at least a first fuel cell and the at least a second fuel cell being separated by a partition member.

17. An apparatus for producing electrical energy, the apparatus comprising a fuel cell system comprising:
at least a first cell having at least one anode compartment housing an anode electrode and acidic electrolyte, at least one cathode compartment housing a cathode electrode and alkaline electrolyte, the at least one anode compartment and the at least one cathode compartment being separated by a partition member.
